(19) United States
(12) Patent Application Publication
(10) Pub. No.: US 2007/0189485 A1
(43) Pub. Date: Aug. 16, 2007

(54) Marine switching system for providing time information and method thereof

(76) Inventor: Joon-Beom Jeon, Suwon-si (KR)

Correspondence Address: Robert E. Bushnell, Suite 300, 1522 K Street, N.W., Washington, DC, 20005, US

(21) Appl. No.: 11/653,245

(22) Filed: Jan. 16, 2007

(30) Foreign Application Priority Data
Jan. 20, 2006 (KR) 10-2006-0006513

(51) Int. Cl. H04M 3/42

(52) U.S. Cl. 379/201.01

(57) ABSTRACT

A marine switching system providing time information and a method thereof are provided. The marine switching system includes a marine clock, a key-phone system, and at least one key-phone terminal. The marine clock detects a current local time according to the longitude at which a ship is located, and outputs current time data that includes the detected current local time. The key-phone system receives the current time data outputted from the marine clock, and extracts the information of the current time. The key-phone terminal receives the current time information from the key-phone system, and updates the current time. Thus, ship passengers can more conveniently check a local time of the current location of a ship.

### CLAIM OF PRIORITY

This application makes reference to, incorporates the same herein, and claims all benefits accruing under 35 U.S.C. §119 from an application for MARINE SWITCHING SYSTEM FOR PROVIDING TIME INFORMATION AND METHOD THEREOF earlier filed in the Korean Intellectual Property Office on the 20 Jan. 2006 and there duly assigned Serial No. 10-2006-0006513.

### BACKGROUND OF THE INVENTION

1. Field of the Invention

The present invention relates to a marine switching system for providing time information and a method thereof.

2. Description of the Related Art

Recently, many of companies and offices are using a digital key-phone system, which provides a connection to an office line, connects between extensions for extension subscribers using a private branch exchange (PBX) and a telephone circuit in a corresponding switching section (generally, called an office line), and has several other additional functions.

A key-phone main device is connected to a public switched telephone network (PSTN), and makes an office line call and an extension call between terminals through a general terminal and a key-phone terminal subscribed to the key-phone main device of the digital key-phone system. Of course, the plurality of terminals can be connected depending on the subscription capacity of the key-phone system. Such a key-phone system provides additional functions to users, such as a voice mail system (VMS), maintenance and management (e.g., MAP), and provision of present time information.

Large-sized ships have a key-phone system for smooth communication in the ships. In large-sized ships, a digital key-phone terminal generally has a display window such as a LCD to display current time. Meanwhile, there are many time zones in the world, in which current local time goes fast or slow by one hour as the longitude changes by 15° on the basis of the longitude 0°. Accordingly, large-sized ships sailing over the world have a specially manufactured marine clock that is designed to provide local time.

### SUMMARY OF THE INVENTION

It is an objective of the present invention to provide a marine switching system for providing time information, which receives information on a current local time that is included in time data having a certain format and outputted from a marine clock, and delivers the information of the current local time to a key-phone terminal, and a method thereof.

In one aspect of the present invention, a marine switching network includes a marine clock, a key-phone system, and at least one key-phone terminal. The marine clock detects a current local time of the longitude at which the marine clock is located, and outputs time data having the current time. The key-phone system receives the time data outputted from the marine clock, extracts information of the current local time, and outputs a data packet including the current time information. The key-phone terminal receives the current time information included in the data packet from the key-phone system, and updates the current time of the key-phone terminal.

The key-phone system may include a time extracting unit receiving the current time data from the marine clock and extracting the current time information from the received current time data, and a time updating unit delivering the extracted current time information to the at least one key-phone terminal.

The current time data transmitted by the marine clock may include a header field, a universal time coordinated (UTC) field, a date field, a local zone hour field, and a local zone minute field. The local zone hour field corresponds to information of time difference between the UTC and the local time at the current location of the ship. Thus, the time extracting unit obtains the local zone hour information by extracting the time information from the UTC field and the local zone time field, and by adding the time information of the UTC field and the local zone time field. The time extracting unit also obtains information on minute and second by extracting information from the local zone minute field.

The key-phone system transmits and receives data to and from the marine clock using a serial input/output port or a local area network (LAN) port.

The key-phone terminal may include a time packet decoder extracting the current time information from the data packet received from the key-phone system, a first clock unit storing and updating the current time with the extracted the current time information, and a display unit for displaying the current local time.

The key-phone terminal may further include a second clock unit for storing and displaying a user time information set by a user, and a mode setting unit for controlling the display unit to display the current time outputted from either the first or the second clock unit. The mode setting unit may control the display unit to display both of the time outputted from the first and the second clock units.

In another aspect of the present invention, a marine key-phone system includes a time extracting unit receiving time data from the marine clock, and extracting current time information from the received time data, and a time updating unit delivering the extracted current time information to at least one key-phone terminal.

The current time data transmitted and received to and from the marine clock may include a header field, a UTC field, a date field, a local zone hour field, and a local zone minute field. The local zone hour field corresponds to information of time difference between the UTC and the local time of the current location of a ship. Thus, the time extracting unit can obtain the current local time information by extracting time information from the UTC field and the local time of the current location of the ship, and adding the time information of the UTC field and the local time. The time extracting unit also obtains information on minute and second by extracting information from the local zone minute field.

Also, the key-phone system is characterized by transmitting and receiving data to and from the marine clock using a serial input/output port or a LAN port.

In another aspect of the present invention, a method of providing time information using a marine key-phone system includes the steps of receiving current time data from a marine clock, detecting a current time according to the longitude of the location of a ship, and extracting and delivering the current time information from the received current time data to a key-phone terminal.

Here, the current time data transmitted by the marine clock may include a header field, a UTC field, a date field, a local zone hour field and a local zone minute field. The local zone hour field corresponds to time difference between the UTC and the local time of the current location of the ship.

The step of extracting the current time information may comprise the steps of obtaining information of the current local zone hour by extracting time information from the UTC and the local zone hour field and by adding time information of the UTC and the local zone hour field, and extracting time information from the local zone minute field and obtaining information of the minute and the second. Also, the data transmission and reception between the marine clock and the key-phone system is performed using a serial input/output port or a LAN.

### BRIEF DESCRIPTION OF THE DRAWINGS

More complete appreciation of the invention and many of the attendant advantages thereof will be readily apparent as the same becomes better understood by reference to the following detailed description when considered in conjunction with the accompanying drawings in which like reference symbols indicate the same or similar components, wherein:

FIG. 1 is a block diagram illustrating a configuration of a general marine clock, a key-phone system, and key-phone terminals;

FIG. 2 is a block diagram illustrating an internal structure of a marine key-phone system constructed as an exemplary embodiment of the present invention;

FIG. 3 is a block diagram illustrating a format of time data constructed as an exemplary embodiment of the present invention;

FIG. 4 is a flowchart illustrating a method for displaying time in a marine key-phone system according to an exemplary embodiment of the present invention;

FIG. 5 is a block diagram illustrating an internal structure of a key-phone system and a key-phone terminal constructed as another exemplary embodiment of the present invention; and

FIG. 6 is a flowchart illustrating a selective time display method in a marine key-phone system according to another exemplary embodiment of the invention.

### DETAILED DESCRIPTION OF EXEMPLARY EMBODIMENTS

Hereinafter, exemplary embodiments of the present invention will be described in detail with reference to the accompanying drawings. In the following description, a detailed description of known functions and configurations incorporated herein has been omitted for conciseness.

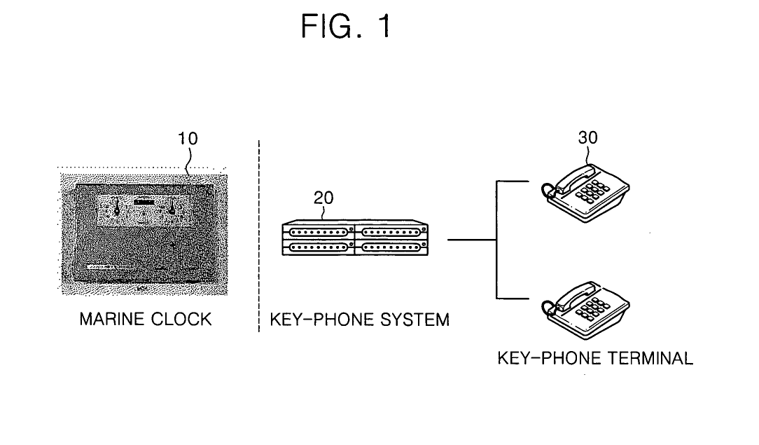

FIG. 1 is a block diagram illustrating the configuration of a general marine clock, a key-phone system, and key-phone terminals. As illustrated in FIG. 1, marine clock 10 and key-phone system 20, which are generally equipped on a ship, operate independently. Marine clock 10 detects present local time according to a location of the ship and displays the time on a display unit of marine clock 10. In the meantime, key-phone terminal 30 connected to key-phone system 20 support a call between ship passengers. A user can set a clock embedded in the key-phone terminal 30, and check the time displayed on the display unit of key-phone terminal.

However, the independent arrangement of marine clock 10, key-phone system 20 and key-phone terminal 30 makes it difficult for the ship passengers sailing over the world to easily check accurate local time through key-phone terminal 30. This is because standard local time changes depending on a change in longitude as the ship travels a long distance, but key-phone terminal 30 cannot automatically change current local time displayed thereon that depends on the location of the ship. Thus, the ship passengers are able to check the local time, which depends on the location of the ship, only on marine clock 10. If a user does not manually set the clock of key-phone system 20 or key-phone terminal 30 according to the local time provided by marine clock 10, the time provided by display devices of key-phone system 20 or key-phone terminal 30 is incorrect.

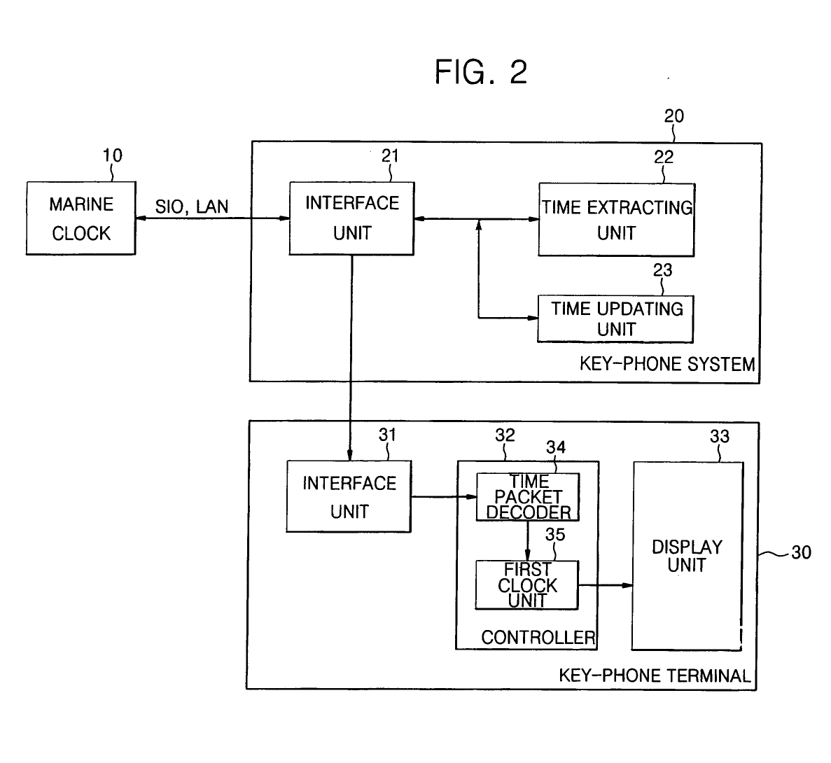

FIG. 2 is a block diagram illustrating an internal structure of a marine key-phone system constructed as an exemplary embodiment of the present invention. As illustrated in FIG. 2, a marine key-phone network may include marine clock 10, key-phone system 20, and key-phone terminal 30.

Marine clock 10 receives information about a current location of a ship through a global positioning system (GPS) satellite and local time that depends on the location of the ship. Marine clock 10 may include a serial input/output (SIO) port, a local area network (LAN) port, and so on for communicating with key-phone system 20. Marine clock 10 transmits current local time data to key-phone system 20 using interfaces listed above.

Key-phone system 20 may include interface unit 21, time extracting unit 22, and time updating unit 23. Because key-phone system 20 is one of switching systems, and can be included in a switching system, it will be apparent that the principles of the present invention can be applied to switching systems. the key-phone system described herein is an example of a switching system.

Interface unit 21 is an element for data communication with marine clock 10. Here, the data transmitted to or received from marine clock 10 includes current local time information. Interface unit 21 may transmit data to or receive data from marine clock 10 through SIO or LAN. A procedure of transceiving a packet using the SIO or LAN is well known, and thus, a description thereof will be omitted.

A format of the time data is defined for communication between key-phone system 20 and marine clock 10, so that key-phone system 20 could extract time information from the data which is received from marine clock 10. The format of the time data used in the present invention will now be described.

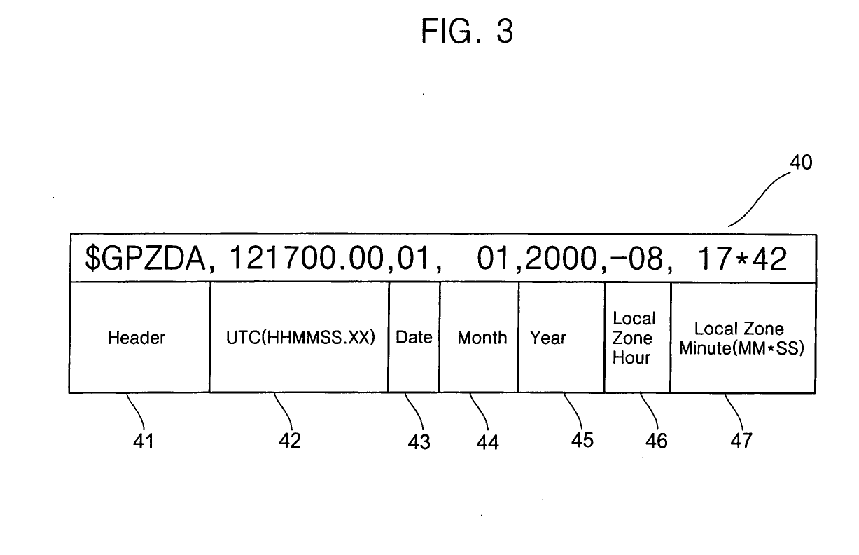

FIG. 3 is a block diagram illustrating a format of time data constructed as an exemplary embodiment of the present invention. Referring to FIG. 3, time data 40 transceiving between marine clock 10 and key-phone system 20 includes a header portion and a payload portion. The header portion may include header field 41, and the payload portion may include Universal Time Coordinated (UTC) field 42, date field 43, month field 44, year field 45, local zone hour field 46, and local zone minute field 47.

Header field 41 indicates that the data is the time data. For example, the header “GPZDA” indicates that the data is the time data based on GPS. UTC field 42 indicates a standard time commonly used in the world. The UTC, which came into effect from Jan. 1, 1972, means a standard time employing, as a reference, a length of the second based on a frequency of a cerium atom defined by the General Conference of Weights and Measures in 1967. Before then, the length of the second was calculated from the mean solar time by the rotation of the Earth and the solar year by the revolution of the Earth. For reference, the mean solar time refers to a Greenwich Mean Time (GMT) which is generally used. For example, when the UTC field 42 has a value of 121700, the mean time of the Earth is 12:17:00, which is almost the same as the GMT.

Year field 45, month field 44, and date field 43 store information of year, month, and date at a current location of the ship, respectively. It can be seen from FIG. 3 that the date at the current location of the ship is Jan. 1, 2000.

Local zone hour field 46 represents information about a time difference between the UTC and the local time of the current location of the ship. It can be seen from FIG. 3 that the value of local zone hour field 46 is “−08.” Accordingly, the ship is located in a zone where local time is 8 hours slower than the UTC. Because the time difference between the local zone hour and the UTC may be up to 12 hours, the absolute value of local zone hour 46 cannot exceed 12.

Also, local zone minute field 47 stores minute and second information at the current location of the ship. Because the minute is identical anywhere in the world, the minute shown in local zone minute field 47 (17 min.) is the same as the minute (17 min.) of UTC field 42. But, it should be noted that the value of the second of local zone minute filed 47 is 42, and key-phone system 20 uses the value of 42 as information of second of the present time. Consequently, as shown in the time data of FIG. 3, marine clock 10 transmits data including time information of Jan. 1, 2000, 4:17:42, which is 8 hrs slower than the UTC. The other components of the key-phone system will now be described.

Referring to FIGS. 2 and 3, time extracting unit 22 extracts the present time from the time data received through interface unit 21. In particular, time extracting unit 22 extracts the time information from UTC field 42 and local zone hour field 46, and adds the values of UTC field 42 and Local zone hour field 46. Time extracting unit 22 also extracts minute and second information from local zone minute field 47.

Time updating unit 23 updates the present time of key-phone system 20, and also updates the present time of key-phone terminal 30 by transmitting the extracted time information to key-phone terminal 30. Time updating unit 23 also produces packets to be transmitted to key-phone terminal 30. A method of transmitting the packets from a main body of key-phone system 20 to key-phone terminal 30 is identical with the conventional technique, and a detailed description of the method will be omitted herein.

Key-phone terminal 30 connected with key-phone system 20 may include interface unit 31, controller 32, and display unit 33. Interface unit 31 transmits data to or receives data from key-phone system 20 or another key-phone terminal 30. Display unit 33 displays the current state of key-phone terminal 30, the operation status of key-phone terminal 30, and particularly the present time.

Controller 32 of the key-phone terminal controls a call function which is generally performed by key-phone terminal 30. In the present invention, controller 32 may include time packet decoder 34 and first clock unit 35. Time packet decoder 34 and first clock unit 35, however, may be independently configured from controller 30, or may not be included in controller 30.

First clock unit 35 detects the present time that will be displayed on display unit 33 of key-phone terminal 30. Time packet decoder 34 extracts time information from the packet received from key-phone system 20, and supplies the extracted time information to first clock unit 35. First clock unit 35 updates the present time on the basis of the newly received time information, and transmits the present time to display unit 33 to display the present time.

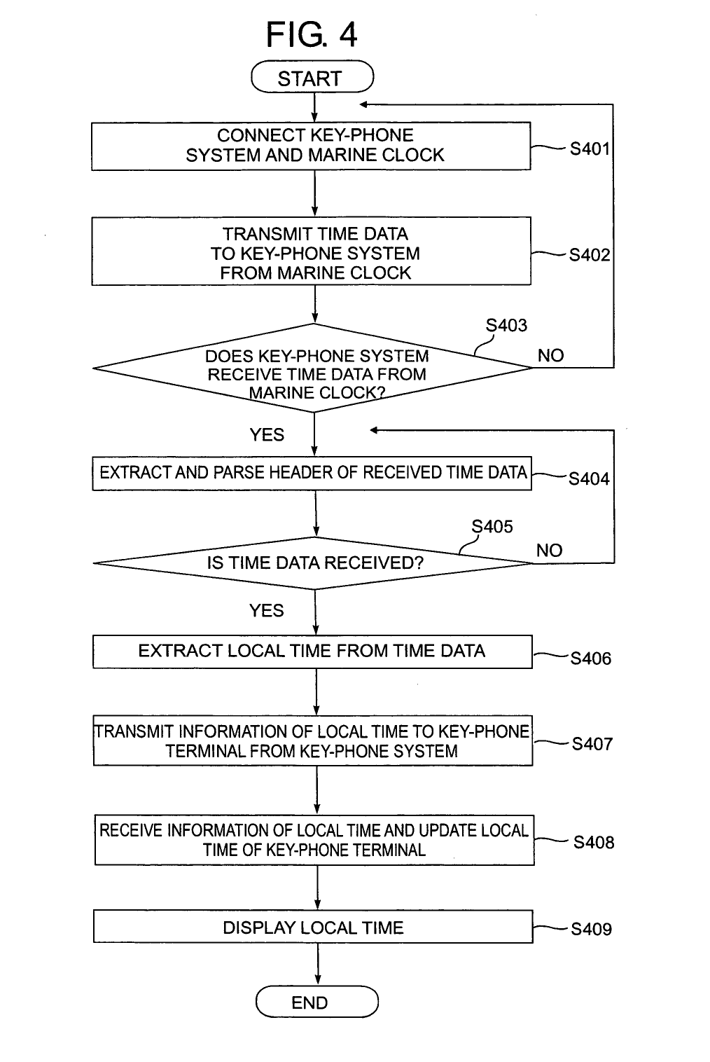

A flowchart shown in FIG. 4 illustrates a method for displaying time in a marine key-phone system that is constructed as an exemplary embodiment of the present invention. First, a key-phone system and a marine clock are connected to each other to communicate with each other.(S401). The marine clock transmits data to the key-phone system (S402). The data includes current local time information that will change depending on the location of a ship. The structure of the data transmitted from the marine clock is shown in FIG. 3. The key-phone system checks whether data is received from the marine clock (S403). If the key-phone system received data from the marine clock, the key phone system extracts and parses a header of the received data (S404), and determines whether the header of the received data indicates that the current local time information is included in the data (S405).

When it is determined that the header of the data does not indicate a predetermined time data packet such as GPZDA, ZQZDA, and so on, the key-phone system waits to receive the time data from the marine clock. When it is determined that the received data carry the current time information, the key-phone system parses a payload portion of the data, and extracts the current time information (S406). A method of extracting such current time information is the same as described above. The extracted current time information is converted into a packet, and transmitted to a key-phone terminal (S407), and the key-phone terminal extracts the current time information from the packet, and updates the current time of the key-phone terminal (S408). The key-phone terminal displays the current time based on the updated time (S409).

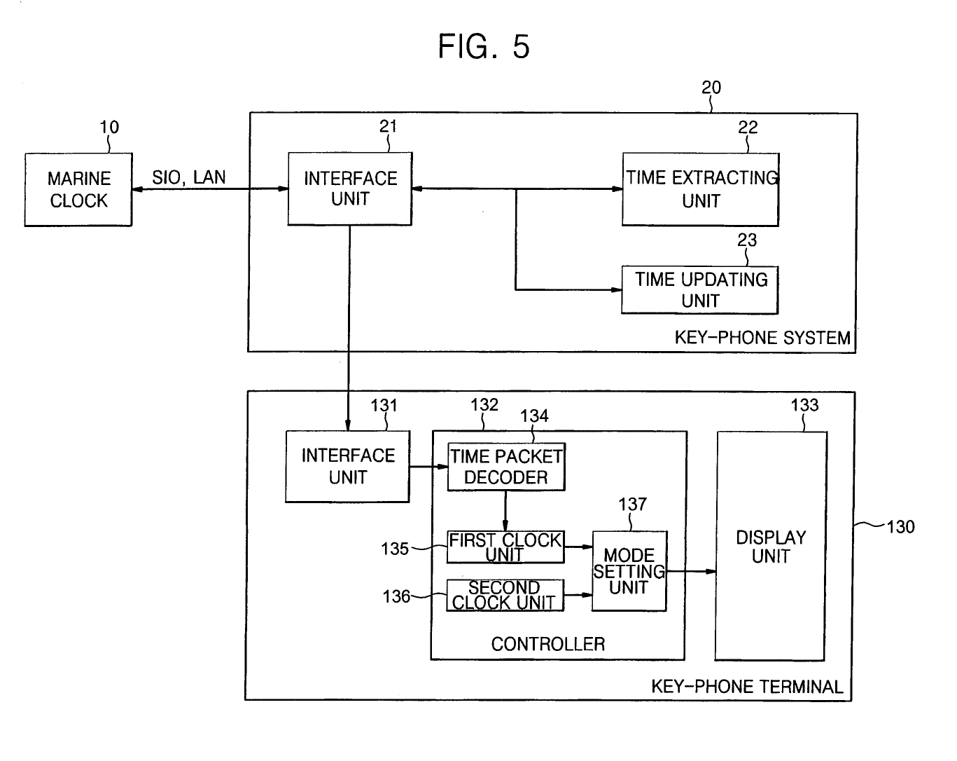

FIG. 5 is a block diagram illustrating an internal structure of a key-phone terminal constructed as another exemplary embodiment of the present invention. As illustrated in FIG. 5, according to the exemplary embodiment, controller 132 of key-phone terminal 130 is characterized by mode setting unit 137 and second clock unit 136.

With key-phone system 20 and key-phone terminal 30 shown in FIG. 2, ship passengers 8 can recognize only local time that depends on the current location of the ship. However, the passenger may desire to set the time of a departing place or an arriving place in advance, and may desire to conveniently check the time of the departing or arriving place. The embodiment shown in FIG. 5 can satisfy such a demand of the passenger.

First clock unit 135 has the same function as first clock 35 shown in FIG. 2. That is, the time information extracted by time packet decoder 134 is transmitted to first clock unit 135. First clock unit 135 updates current time based on the transmitted time information. Second clock unit 136 updates time based on time information that is manually set by a user. The user can manually set time of a desired zone using a key button (not shown) of key-phone terminal 130.

The user can also set key-phone terminal 130 either to display the current local time that depends on the location of a ship, or to display the time that is set by the user. If the user set key-phone terminal 130 to display the local time of the current location of the ship, mode setting unit 137 delivers output from first clock unit 135 to display unit 133. If the user set key-phone terminal 130 to display the time that is manually set by the user, mode setting unit 37 delivers the time information outputted from second clock unit 36 to display unit 33. It may be possible to set key-phone terminal 130 to display both of the current local time and the time set by the user.

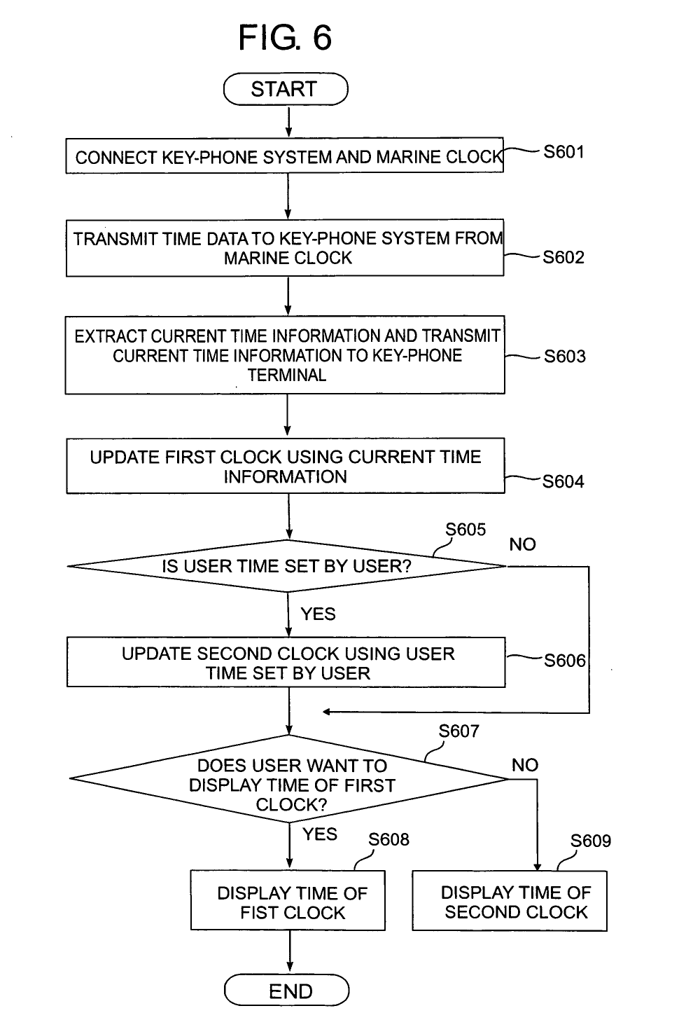

FIG. 6 is a flowchart illustrating a method for selectively displaying time in a marine key-phone system constructed as another exemplary embodiment of the invention. First, a key phone system and a marine clock are connected to each other to communicate with each other (S601). The marine clock transmits data, which includes current time information that changes depending on a location of a ship, to the key-phone system (S602).

When it is determined that the received data carry the current time information, the key-phone system parses a payload portion of the data, extracts the current time information, and transmits the information to the key-phone terminal (S603). The key-phone terminal extracts the current time information from the packet to update the first clock (S604). The key-phone terminal checks whether the user manually sets user time (S605). If the user manually sets the user time, the key-phone terminal updates the second clock using the time set by the user (S606).

The key phone terminal also checks whether the user wants to display the local time of the first clock at the location of the ship or to display the time of the second clock that is manually set by the user (S607). If it is determined that the user wants to display the current local time, the key-phone terminal displays the time outputted from the first clock unit (S608). On the other hand, if the user wants to display the time set manually by the user, the key-phone terminal displays the time outputted from the second clock unit (S609).

While the present invention exemplifies the marine key-phone system herein, the principle of the present invention can be applied to any device that travels broad range of area and therefore experiences change in time depending on the longitude. It is apparent that the key-phone system and the method described in the present invention can be applied to key-phone systems of any transportation system such as airplanes, trains, or vehicles. In the description of the embodiments of the present invention, the terminology of a ship is used to represent a transportation system or a moving device, and is not limited to a ship of a general conception.

As described above, according to the marine key-phone system for providing time information and the method thereof, a key-phone terminal displays current time on the basis of the current time information received from the marine clock which provides the current time information depending on the location of a ship, and thus ship passengers can more conveniently check the current local time.

While the present invention has been described with reference to exemplary embodiments thereof, it will be understood by those skilled in the art that various changes in from and detail may be made therein without departing from the scope of the present invention as defined by the following claims.

What is claimed is:

1. A marine switching network, comprising:
a marine clock for detecting a current local time of the longitude at which the marine clock is located, the marine clock outputting time data including the detected current local time;
a key-phone system coupled to the marine clock, the key-phone system receiving the time data from the marine clock, extracting information of the current local time from the time data, and outputting a data packet including the information of the current local time; and
a key-phone terminal coupled to the key-phone system, the key-phone terminal receiving the data packet from the key-phone system and updating current time of the key-phone terminal to the current local time.

2. The marine switching network of claim 1, comprised of the key-phone system including:
a time extracting unit receiving the time data from the marine clock, and extracting the information of the current local time from the time data; and
a time updating unit outputting the data packet including the extracted information of the current local time to the key-phone terminal.

3. The marine switching network of claim 2, comprised of the time data including a header field, a universal time coordinated field, a date field, a local zone hour field, and a local zone minute field.

4. The marine switching network of claim 3, comprised of the local zone hour field including information on time difference in hour between the universal time coordinated and the current local time.

5. The marine switching network of claim 4, comprised of the time extracting unit obtaining hour information of the current local time by extracting hour information from the universal time coordinated field and the local zone hour field, and by adding the extracted hour information of the universal time coordinated field and the local zone hour field, the time extracting unit obtaining information on minute and second by extracting information of the local zone minute field.

6. The marine switching network of claim 2, comprised of the key-phone system including an interface unit for transmitting and receiving data to and from the marine clock through a serial input/output port or a local area network port.

7. The marine switching network of claim 1, comprised of the key-phone terminal including:
a time packet decoder for extracting the information of the current local time from the data packet received from the key-phone system;
a first clock unit for storing the current local time obtained from the extracted information of the current time; and
a display unit for receiving the current local time from the first clock unit and for displaying the current local time.

8. The marine switching network of claim 7, wherein the key-phone terminal further comprises:
a second clock unit for storing a user time set by a user; and
a mode setting unit for controlling the display unit to display the time either stored in the first clock unit or stored in the second clock unit.

9. The marine switching network of claim 7, wherein the key-phone terminal further comprises:
a second clock unit for storing a user time set by a user; and
a mode setting unit for controlling the display unit to display both of the time stored in the first clock unit and the time stored in the second clock unit.

10. A marine key-phone system, comprising:
a time extracting unit for receiving time data from a marine clock, and for extracting information of a current local time from the received time data; and
a time updating unit for delivering the extracted information of the current local time to a key-phone terminal.

11. The key-phone system of claim 10, wherein the time data including a header field, a universal time coordinated field, a date field, a local zone hour field, and a local zone minute field.

12. The key-phone system of claim 11, comprised of the local zone hour field including information on time difference in hour between the universal time coordinated and the current local time.

13. The key-phone system of claim 12, comprised of the time extracting unit obtaining hour information of the current local time by extracting hour information from the universal time coordinated field and the local zone hour field, and by adding the extracted hour information of the universal time coordinated field and the local zone hour field, the time extracting unit obtaining information on minute and second by extracting information of the local zone minute field.

14. The key-phone system of claim 10, wherein the key-phone system transmits and receives data to and from the marine clock through a serial input/output port or a local area network port.

15. The key-phone system of claim 10, wherein the current local time is detected by the marine clock, and the current local time is a local time of the longitude at which the marine clock is located.

16. A method of providing time information using a marine key-phone system, comprising the steps of:
receiving time data from a marine clock, the time data including a current local time of a longitude of a location of the marine clock, the time data being detected by the marine clock;
extracting information of the current local time from the time data; and
delivering the information of the current local time to a key-phone terminal.

17. The method of claim 16, comprised of the time data including a header field, a universal time coordinated field, a date field, a local zone hour field, and a local zone minute field.

18. The method of claim 17, comprised of the local zone hour field including information on time difference in hour between the universal time coordinated and the current local time.

19. The method of claim 18, comprised of the step of extracting information of the current local time including the steps of:
obtaining hour information of the current local time by extracting hour information from the universal time coordinated field and the local zone hour field, and by adding the extracted hour information of the universal time coordinated field and the local zone hour field; and
obtaining information on minute and second by extracting information of the local zone minute field.

20. The method of claim 16, wherein receiving time data from a marine clock is performed through a serial input/output port or a local area network port.
